(19) United States
(12) Patent Application Publication
(10) Pub. No.: US 2008/0286726 A1
(43) Pub. Date: Nov. 20, 2008

(54) MOTION SIMULATOR AND METHOD

(76) Inventor: David G. Bennett, Boston (GB)

Correspondence Address: Intellevate, P.O. Box 52050, Minneapolis, MN, 55402, US

(21) Appl. No.: 11/946,063

(22) Filed: Nov. 28, 2007

(30) Foreign Application Priority Data
May 16, 2007 (GB) GB0709479.0

(51) Int. Cl. G09B 9/02

(52) U.S. Cl. 434/29

(57) ABSTRACT

A method, apparatus and system of a motion simulator is disclosed. In one embodiment, a motion simulator not resorting to conventional principles nor employing any fluid or pneumatic components to derive motion with 6 degrees of freedom. Motion derived from bi-directional low voltage motors controlled through a Human Computer Interface Device is described which achieves 120 degrees of “Pitch & Roll” through rotation of ball screws acting through “spherical ball joints”. “Yaw”, “Rising and Descending” independently achieved through “rack and pinions” acting upon the central spherical pivot and rotational plates. The lower “spherical ball joints” firmly securing the ball screw's bearings, motor and coupling, the upper spherical ball joints mounted on slide-able bearing plates which encase the ball nut. The above providing proportionality between two sets of (ball screws) linear actuators. Rotation induced into the “spherical ball-joint” opposed to the direction of motor and screw is overcome by employing a “hardening peg”, “bearing” and “track” sunk into a surface of the “spherical ball-joint”.

### CLAIMS OF PRIORITY

This patent application claims priority from a United Kingdom Patent Application filed in the United Kingdom, Application No. GB0709479.0 filed on May 16, 2007.

### FIELD OF TECHNOLOGY

This disclosure relates generally to technical fields of simulation devices and, in one embodiment, to a motion simulator to achieve six-degrees of freedom.

### BACKGROUND

Generally and whilst the qualified Commercial Pilot (CPL) undertakes higher training such as Airline Transport Pilot (ATPL), the airline industry introduces motion simulators in order to evaluate, monitor and assess certified and pre-certified personnel, their capabilities without risk to “man and machine”. These “high-end” simulation machines provide six directions of freedom (“6-DOF”) with motion derived through hydraulic forces, cylinders, pumps, electromagnetic solenoid valves. Thus, the associated complexity of design and high financial costs do not allow introduction of these motion simulation machines into the initial, primary assessment of abilities, capabilities of prospective Private Pilots (PPL) in General Aviation or indeed those undertaking initial training and assessments as Commercial Pilots (CPL).

### SUMMARY

A method, apparatus, and system of a motion simulator are disclosed. In one aspect, a method of a motion simulator includes achieving 6-degrees of freedom without resorting, nor deriving motion from employing equipment actuated by at least one of fluid, air pressure, pipes, pumps, mechanically operated valves and solenoids, and electrically operated valves and solenoids. The method may achieve the motion through encasing a ball nut within a sphere, being subsequently held between two plates having machined internal surfaces matching a external radius of the sphere hereinafter termed a “spherical ball-joint” allowing and providing the ball nut with rotational and angular movement whist maintaining its respective center within the sphere.

In addition, the method may include encasing supporting bearings of a ball screw and a coupling within the sphere, being subsequently held between two plates having machined internal surfaces matching the external radius of the sphere hereinafter termed the “spherical ball-joint” allowing and providing the ball screw and coupling with rotational and angular movement whist maintaining their respective centers within the sphere The method of the motion simulator may include placing a pair of “spherical ball-joints”, vertically above but distant from each other however joined and affixed by the ball screw, in such allowing for proportional angular movement of the spheres and the ball screw should the “spherical ball-joints” be moved from and out of a vertical position. Further, the method may permit allowing an uppermost “spherical ball-joint” to “tilt” and proportionally at least one of increase and decrease in their “arc and position” from the central spherical pivot point hence, with and upon rotation of the ball screw and a subsequent at least one of a rise and a fall in a height of an encased ball nut, an introduction of the ball screw to rotation within a conical envelope.

A low voltage bi-directional motor may be affixed to a coupling of the ball screw which is encased but not constrained within the “spherical ball-joint”. The method may restrict the counter rotation forces applied to the sphere within at least one of the “spherical ball-joints” upon motors thus ball screw rotation by insertion of a “hardening peg” along with “bearing” into an elliptical hardened “track” sunk into a surface of at least one of the “spherical ball-joints”.

In another aspect, a motion simulator achieves 6-degrees of freedom without resorting, nor deriving motion from employing equipment actuated by at least one of fluid, air pressure, pipes, pumps, mechanically operated valves and solenoids, and electrically operated valves and solenoids. The motion simulator may include a ball nut within a sphere encased, being subsequently held between two plates having machined internal surfaces matching an external radius of the sphere hereinafter termed the “spherical ball-joint” allowing and providing the ball nut with rotational and angular movement whist maintaining its respective center within the sphere. In addition, the motion simulator may include supporting bearings of a ball screw and a coupling within the sphere encased, being subsequently held between two plates having machined internal surfaces matching the external radius of the sphere hereinafter termed the “spherical ball-joint” allowing and providing the ball screw and coupling with rotational and angular movement whist maintaining their respective centers within the sphere. A pair of “spherical ball-joints” placed vertically above but distant from each other however joined and affixed by the ball screw may be include, in such allowing for proportional angular movement of the spheres and the ball screw should at least one of the “spherical ball-joints” be moved from and out of the vertical position, wherein an uppermost “spherical ball-joint” permitted to “tilt” and proportionally at least one of increase and decrease in their “arc and position” from the central spherical pivot point hence, with and upon rotation of the ball screw and a subsequent at least one of a rise and a fall in a height of an encased ball nut, an introduction of the ball screw to rotation within a conical envelope. A low voltage bi-directional motor may be provided to a coupling of the ball screw which is encased but not constrained within the “spherical ball-joint” (e.g., the counter rotation forces applied to the sphere are restricted within at least one of the “spherical ball-joints” upon motors thus ball screw rotation by insertion of a “hardening peg” along with “bearing” into an elliptical hardened “track” sunk into a surface of at least one of the “spherical ball-joints”).

The method may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a cross sectional view of the bearing plates encasing an upper “spherical ball-joint’ and the elliptical shape of the “track” as sunken into the surface of the sphere, according to one embodiment.

FIG. 2 is a frontal view of the bearing plates encasing an upper “spherical ball-joint” and the elliptical shape of the “track” as sunken into the surface of the sphere, according to one embodiment.

FIG. 3 is an upper “spherical ball-joint” assembled into a set of “slotted arms”, wherein two sets of “slotted arm” assemblies may be mounted at 90 degrees apart, secured to and extending from the bearing plates encasing the central spherical pivot, according to one embodiment.

FIG. 4 is a cross-sectional view of an upper “spherical ball-joint” within a set of slotted arms, according to one embodiment.

FIG. 5 is a cross sectional view of a lower “spherical ball-joint”, its internal components and bearing plates thereof, wherein two of these assemblies may be opposed at 90 degrees, to secure the low voltage motors and their coupling to the ball screws which in turn transfer their rotational force to the ball nuts encased within the upper “spherical ball-joints”, according to one embodiment.

FIG. 6 is a cross sectional view showing the central spherical pivot, its support, upper and lower bearing plates and a mechanism to achieve 45 degrees of “Yaw” independently of the other major axis of “Pitch & Roll” and that of “Lift & Descend”, according to one embodiment.

FIG. 7 is an arrangement view of directions of movement around the central spherical pivot and the location of low voltage motors, according to one embodiment.

Other features of the present embodiments will be apparent from the accompanying drawings and from the detailed description that follows.

### DETAILED DESCRIPTION

A method and system of a motion simulator is disclosed. In the following description, for purposes of explanation, numerous specific details are set forth in order to provide a thorough understanding of the various embodiments. It will be evident, however, to one skilled in the art that the various embodiments may be practiced without these specific details.

This invention relates to using machined spheres to form “spherical ball-joints” and additionally, ball screws, ball nuts, low voltage motors and a counter reactive mechanical device to achieve the invention's practical application as a motion simulator providing 120 degrees of movement in the two major axis of “Pitch and Roll”, 45 degrees of “Yaw” and allowing “6-directions of freedom” hereinafter termed “6-DOF”.

This invention does not require the usage of complex and expensive hydraulic or pneumatic components to achieve “6-DOF” thus the invention allows for “low cost” assessment of prospective pilots, their physical abilities, aptitude and mental-status prior to their or family's significant financial investment in course fees and airborne training.

The invention proposes a motion simulation machine having “6-DOF” and 120 degrees of movement about its central spherical pivot, employing low voltage motors to achieve controlled rotation of ball screws within captive ball nuts, whilst allowing the ball screws to longitudinally self-center. The invention allows proportionality usually associated with electronic gearing through usage of “spherical ball-joints”, their counter rotational forces being restricted. Motor control is achieved through a programmable controller with voltage inputs in the form of “signals” being through a Human Interface Device (HID) namely a “joystick”.

The invention uses an additional motor, independently controlled and devoid of any relationship to the aforementioned major axis of “Pitch & Roll”, to achieve 45 degrees of “Yaw” within any such degrees of arc the major axis may take. The bearing plates encasing the central spherical pivot and those encasing the upper and lower “spherical ball-joints” contain such removable plates that allow eradication of frictional wear as would occur time to time. Additionally and as per necessity, the bearing plates are individually “matched marked” to their respective sphere thus interchangeable as full assemblies only.

The invention allows the upper bearing plates to “tilt” proportionally upon and to any increase or decrease in the free distance between the lower “spherical ball-joints” and that of the ball nuts encased in the upper “spherical ball-joints”.

The spheres forming the “spherical ball-joints” within the upper and lower bearing plates, allow their respective ball screw or ball nut, angular freedom within the bearing plates thus assuring proportionality of movement within the invention.

Within the bearing plates, the invention uses a counter reactive “hardened peg”, “bearing” and “track” to restrict rotation of the sphere within the “spherical ball-joint” that would naturally occur upon motor rotation. The invention uses another motor through a conventional “rack & pinion” arrangement to vertically lift and lower the central spherical pivot. The invention will now be described by reference to the accompanying drawings and by explanation of how the invention may be performed.

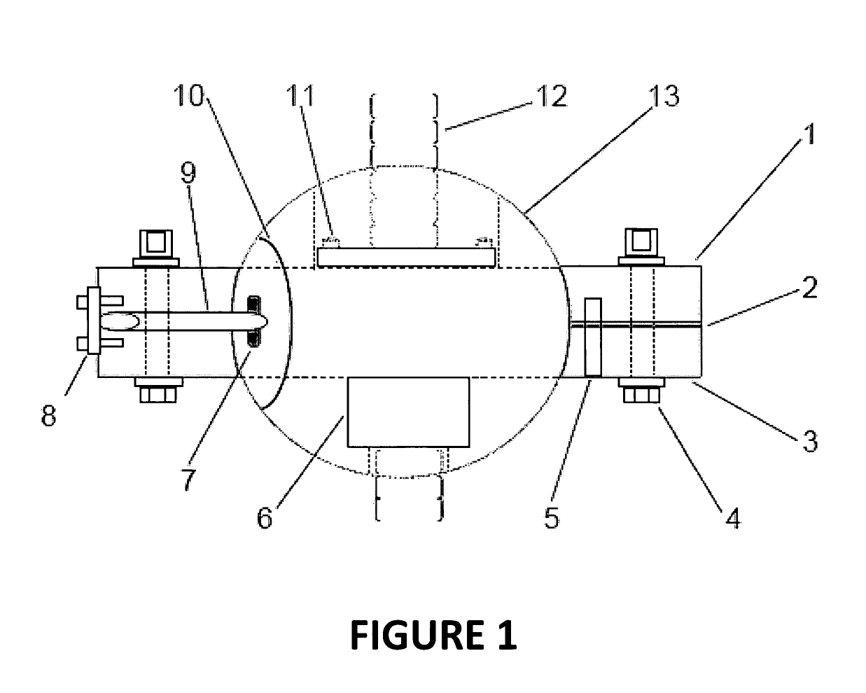

In FIG. 1, the configuration of the upper “spherical ball-joint” for which there are two of per invention opposed at 90 degrees, allows the encasement and captivation of a ball nut (6) whilst allowing and retaining its ability to turn through an included angle of 120 degrees after which physical contact occurs between the internal edges of the bearing plates (1 & 3) and the ball screw's (12) outer circumference. The bearing plates (1 & 3) replicate the outer radius of the sphere allowing for clearances measurable in microns, upon these clearances becoming excessive then the invention allows for the removal of plates (2) thus the elimination of frictional wear which may occur from time to time.

There is a necessity for the bearing plates (1 &3) and their corresponding sphere (13) to be “matched marked” hence two of dowels (5) are located 180 degrees apart, between the spherical ball (13) and the barrel bolts (4) securing the assembly. The ball nut (6) firmly secured by cap-head screws (11) converts the ball screw's (12) rotary motion into linear motion and thus the subsequent rise or fall of the bearing plates (1 & 3) within the invention. In order to oppose the rotary movement induced into the sphere (13) a “hardened peg” (9) is inserted through the bearing plates (1 &3) internally securing a “bearing” (7) sunk into a designed, elliptical “track” (10). The bearing (7) does not have contact with the sub-surface of the “track” (10) but acts upon the elliptical edge of the “track-way” corresponding to the position of the sphere (13) thus the angle of the ball screw (12). The “hardened peg” (9) is retained by a plate (8) and two of cap-screws.

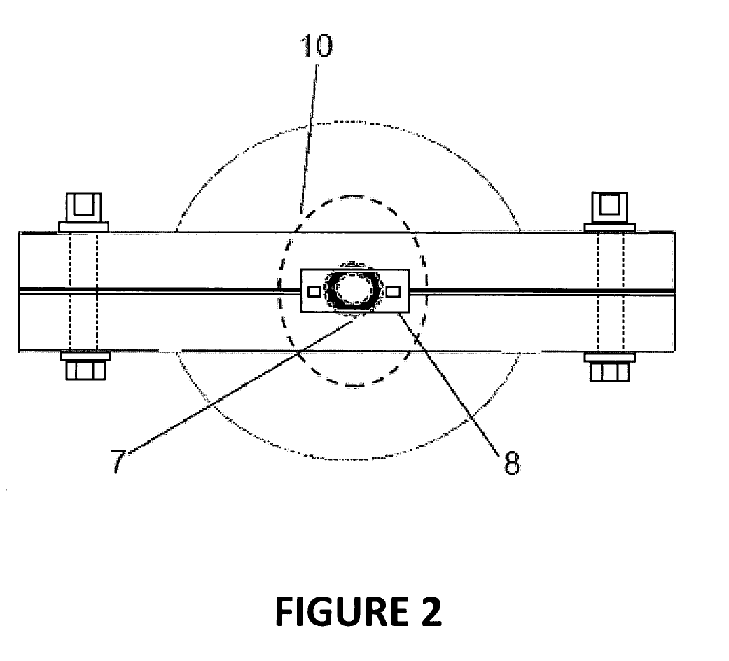

In FIG. 2 the frontal view of a “spherical ball-joint” is depicted as is the elliptical “track-way” (10) and “bearing” (7) which counters and oppose the rotational force applied to the sphere through the ball nut's (6) conversion of the ball screw's rotary motion into linear motion.

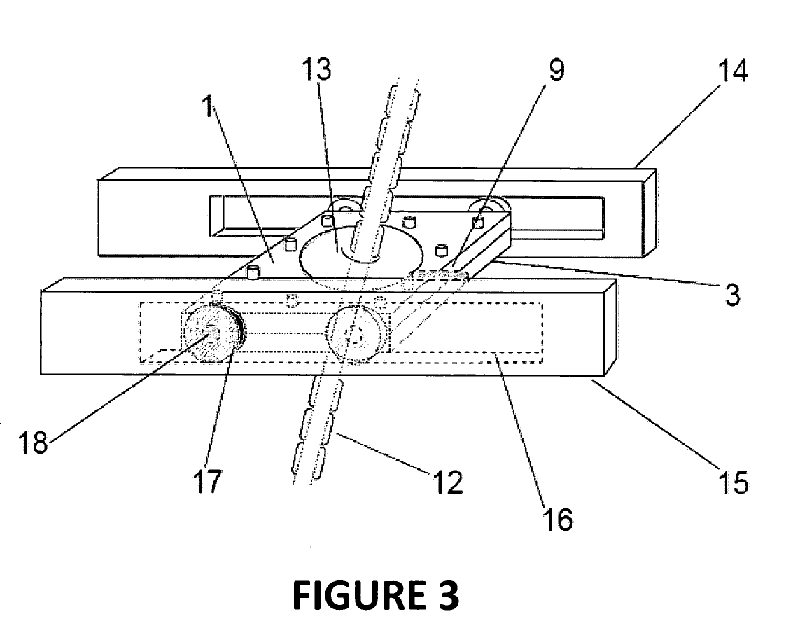

In FIG. 3, an upper “spherical ball-joint” has been assembled into a set of “slotted arms” (14 & 15) with these “slotted arms” subsequently being securely fitted to the upper bearing plates encasing the invention's central spherical pivot. Four of the roller bearings (17) have now been fitted to “axles” (18) sunken into the sides of the bearing plates (1 & 3) thus allowing the complete assembly free movement along the arm's internal slot's (16).

With the usage of four roller bearings (17) and providing them free movement within the internal “slots” (16) the upper “spherical ball-joint” can achieve longitudinal travel thus the “arc” at which the tip or uppermost point of the ball screw (12) travels during rotation is radically reduced whilst maintaining proportionality of movement within the invention.

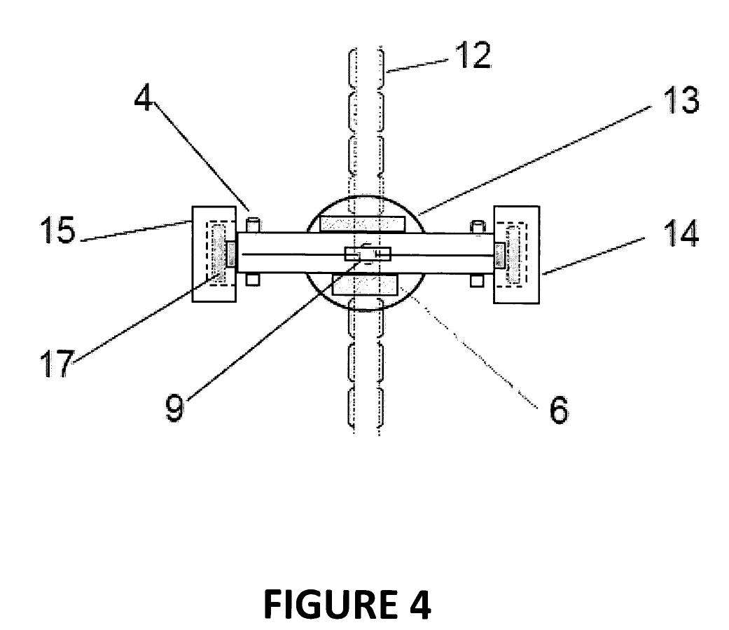

In FIG. 4, it will be seen that the addition of four roller bearings (17) within the “slotted arms” has no effect on the position of the ball nut (6) within the sphere (13) hence included angular movement of 120 degrees remains.

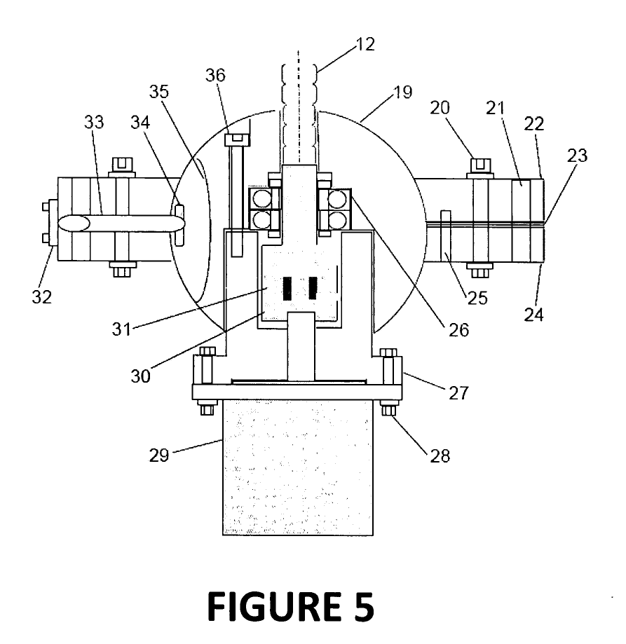

In FIG. 5, it will be noted that basic construction and principle of a lower “spherical ball-joint” follows that of an upper “spherical ball-joint” as described at FIGS. 1 & 2. The sphere (19) is retained by bearing plates (22 & 24) machined internally to replicate the sphere's outer circumference. Both upper and lower bearing plates (22 &24) are “matched marked” through the usage of two dowels (25) at 180 degrees apart, positioned between the plate's six of cap head screws (20) securing the assembly and the joint (19). Removable plates (23) allow for eradication of frictional wear between sphere (19) and bearing plates (22 & 24) whilst four of drillings (21) allow the assembly to be firmly “bolted” to a set of arms affixed to the support of the central spherical pivot.

Notwithstanding, the sphere (19) encases the outer-race of ball screw's bearings (26) but allows free-rotation of the ball screw (12) now being attached to it's upper coupling (31). A bi-directional low voltage motor (29) along with its corresponding free-rotating coupling (30) is fitted against a machined mounting plate (27) which also serves to retain the ball screw' bearings (26) and restrict the screw's end-float during rotation. The machined mounting plate, which secures the motor through bolts (28), is itself secured within the sphere through sunken cap head screws (36) with this feature thus allowing for adjustment to the bearing's (26) pre-load and air-gap between the two halves of the motor coupling.

In order to counter rotation of the sphere (19) and as principally used within the upper “spherical ball-joints”, a plate along with cap head screws (32) secures a “hardened peg” (33), inserted through the bearing plates (22 & 24), internally securing a “bearing” (34) sunken into a designed, elliptical “track” (35). The “bearing” (34) does not have contact with the “tracks” (35) sub-surface but acts upon the elliptical edge of the “track-way” corresponding to the position of the sphere thus the angle of the ball screw.

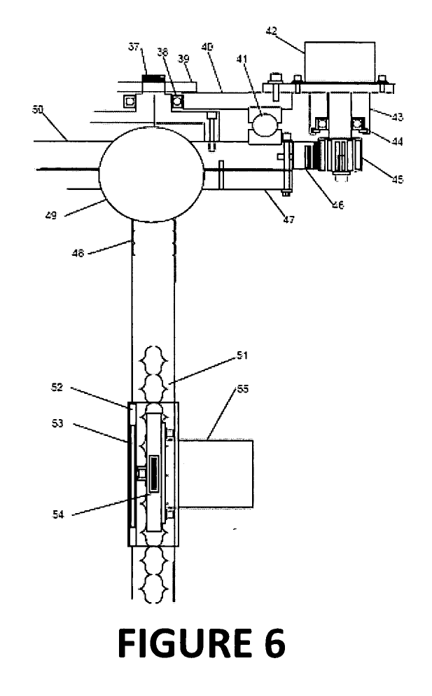

In FIG. 6, it will be noted that the general arrangement of the captive but not constrained sphere (49) termed “central spherical pivot”, between two bearing plates (47 & 50) is as that previously described but obviously larger than, all of those in the aforementioned figures of 1 to 5 inclusive. Notwithstanding and as unique to the central spherical pivot, there is no requirement nor necessity to employ any counter reactive device such as a “hardening peg” or “bearing” within an elliptical “track” or “track-way”.

Above and directly though the vertical center passing through the support (48) and central spherical (49), is a raised “king post” (37) or otherwise know as “center-post”, mounted to the upper and lower bearing plates (47 & 50) at a distance and clear of the central sphere's upper surface. This “king post” allows for fitment of a roller bearing (38) at the center of a plate (40) hereinafter termed the “Yaw-plate”, thus and when outwardly supported in the horizontal by a thrust bearing (41), rotational movement around the “king-post” is achieved in any arc or “tilt” the bearing plates (47 & 50) may encounter upon their movement around the central sphere (48)—the pivot point.

As established, the newly termed “Yaw-plate” (40) is “free to rotate”. Hence and once the central bearing (38) is made captive by an adjustable nut (39) and with a low voltage motor (42) being assembled upon the “Yaw-plate”, it can now provide the inventions source of controlled rotation; that of 45 degrees of “Yaw” upon the motor being fitted with a “pinion” (45) that subsequently engages with and into a matching radial “rack” (46). A machined housing (43) provides stability upon pinion rotation and provides “lands” to affix the pinions lower bearing (44). At the lower of FIG. 6 is the invention's mechanism that achieves “Lift & Decent” that being a “rack” (51) and “pinion” (54). Rotation of the pinion is achieved through the usage of a controllable low voltage motor (55) whilst counter rotation of the spheres support (48) is averted by insertion of a key (53) into a key way (52) constrained within the supports (48) outer casing.

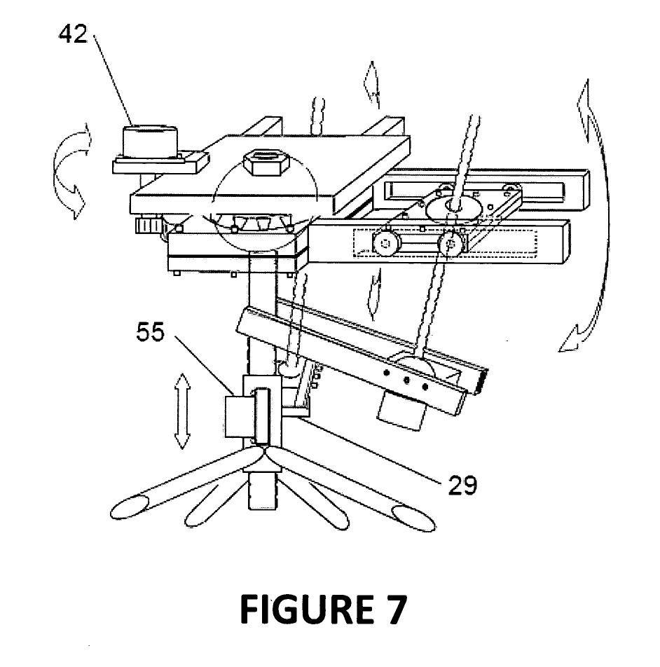

In FIG. 7, the inventions movement, 6-DOF around the central spherical pivot is depicted by the “block arrows”. The low voltage motor depicted at the lower-right and to the forefront provides the bi-directional rotary force allowing the inventions 120 degrees of “Pitch” whilst the other bi-directional motor (29), mounted rearwards and set opposed by 90 degrees, provides the rotary force for 120 degrees of “Roll”. Low voltage motor (42) provides the rotary force for 45 degrees of “Yaw” whist motor (55) provides “lift and descent”.

Although the present embodiments have been described with reference to specific example embodiments, it will be evident that various modifications and changes may be made to these embodiments without departing from the broader spirit and scope of the various embodiments. For example, the embodiments described herein may be enabled and operated using hardware circuitry (e.g., CMOS based logic circuitry), firmware, software and/or any combination of hardware, firmware, and/or software (e.g., embodied in a machine readable medium).

For example, the various aspects and embodiments may be enabled using software and/or using transistors, logic gates, and electrical circuits (e.g., application specific integrated ASIC circuitry) such as a converter circuit, an aggregation circuit, and/or a processing circuit. In addition, it will be appreciated that the various operations, processes, and methods disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than a restrictive sense.

In addition, it will be appreciated that the various operations, processes, and methods disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than a restrictive sense.

What is claimed is:

1. A method of a motion simulator, comprising:
achieving 6-degrees of freedom without resorting, nor deriving motion from employing equipment actuated by at least one of fluid, air pressure, pipes, pumps, mechanically operated valves and solenoids, and electrically operated valves and solenoids.

2. The method of claim 1, further comprising:
achieving the motion through encasing a ball nut within a sphere, being subsequently held between two plates having machined internal surfaces matching a external radius of the sphere hereinafter termed a “spherical ball-joint” allowing and providing the ball nut with rotational and angular movement whist maintaining its respective center within the sphere.

3. The method of claim 2, further comprising:
encasing supporting bearings of a ball screw and a coupling within the sphere, being subsequently held between two plates having machined internal surfaces matching the external radius of the sphere hereinafter termed the “spherical ball-joint” allowing and providing the ball screw and coupling with rotational and angular movement whist maintaining their respective centers within the sphere.

4. The method of the motion simulator of claim 3 further comprising:
placing a pair of “spherical ball-joints”, vertically above but distant from each other however joined and affixed by the ball screw, in such allowing for proportional angular movement of the spheres and the ball screw should the “spherical ball-joints” be moved from and out of a vertical position.

5. The method of claim 4 further comprising:
allowing an uppermost “spherical ball-joint” to “tilt” and proportionally at least one of increase and decrease in their “arc and position” from the central spherical pivot point hence, with and upon rotation of the ball screw and a subsequent at least one of a rise and a fall in a height of an encased ball nut, an introduction of the ball screw to rotation within a conical envelope.

6. The method of claim 5 further comprising:
affixing a low voltage bi-directional motor to a coupling of the ball screw which is encased but not constrained within the “spherical ball-joint”.

7. The method of claim 6 further comprising:
restricting the counter rotation forces applied to the sphere within at least one of the “spherical ball-joints” upon motors thus ball screw rotation by insertion of a “hardening peg” along with “bearing” into an elliptical hardened “track” sunk into a surface of at least one of the “spherical ball-joints”.

8. A motion simulator to achieve 6-degrees of freedom without resorting, nor deriving motion from employing equipment actuated by at least one of fluid, air pressure, pipes, pumps, mechanically operated valves and solenoids, and electrically operated valves and solenoids, comprising:
a ball nut within a sphere encased, being subsequently held between two plates having machined internal surfaces matching an external radius of the sphere hereinafter termed the “spherical ball-joint” allowing and providing the ball nut with rotational and angular movement whist maintaining its respective center within the sphere;
supporting bearings of a ball screw and a coupling within the sphere encased, being subsequently held between two plates having machined internal surfaces matching the external radius of the sphere hereinafter termed the “spherical ball-joint” allowing and providing the ball screw and coupling with rotational and angular movement whist maintaining their respective centers within the sphere;
a pair of “spherical ball-joints” placed vertically above but distant from each other however joined and affixed by the ball screw, in such allowing for proportional angular movement of the spheres and the ball screw should at least one of the “spherical ball-joints” be moved from and out of the vertical position, wherein an uppermost “spherical ball-joint” permitted to “tilt” and proportionally at least one of increase and decrease in their “arc and position” from the central spherical pivot point hence, with and upon rotation of the ball screw and a subsequent at least one of a rise and a fall in a height of an encased ball nut, an introduction of the ball screw to rotation within a conical envelope; and
a low voltage bi-directional motor to a coupling of the ball screw which is encased but not constrained within the “spherical ball-joint”, wherein the counter rotation forces applied to the sphere are restricted within at least one of the “spherical ball-joints” upon motors thus ball screw rotation by insertion of a “hardening peg” along with “bearing” into an elliptical hardened “track” sunk into a surface of at least one of the “spherical ball-joints”.
